(19) United States
(12) Patent Application Publication
(10) Pub. No.: US 2026/0316531 A1
(43) Pub. Date: Oct. 15, 2026

(54) SYSTEM AND METHOD FOR REDUCING GLARE IN WINDSHIELD

(71) Applicant: HCL Technologies Limited, New Delhi (IN)

(72) Inventor: Srinivasan R, Chennai (IN)

(21) Appl. No.: 19/463,191

(22) Filed: Jan. 29, 2026

(30) Foreign Application Priority Data
Apr. 11, 2025 (IN) 202511035406

(51) Int. Cl. B60J 3/04; G02F 1/01; G06F 3/01

(52) U.S. Cl. CPC B60J 3/04; G02F 1/0121; G02F 1/0126; G06F 3/013

(57) ABSTRACT

A system and method for reducing glare in a windshield is disclosed. The system includes a photochromic layer formed on the windshield. The photochromic layer includes a plurality of regions. The system further includes a sensor unit disposed on the windshield configured to generate sensor data based on the influx of light impinging on the plurality of regions. The system further includes a light source configured to impart light on the plurality of regions. The system further includes a control unit communicably coupled to the sensor unit and the light source and configured to generate an activation command and activate the light source to impart light on at least one region from the plurality of regions when the influx of light impinging increases above a predefined influx threshold.

### TECHNICAL FIELD

This disclosure relates generally to the field of a windshield, more particularly to a system and method for reducing glare in the windshield of the vehicle.

### BACKGROUND

Vehicles are furnished with a windshield which provides an aerodynamically designed window at an anterior end. The windshield serves to protect multiple occupants from environmental elements such as wind and debris, including dust, insects, and rocks. Additionally, while transiting, the driver carries the responsibility for ensuring the safe operation of the vehicle and the safety of its occupants. Nonetheless, the driver becomes susceptible to hazards such as crash events, collisions, and the like, when facing oncoming vehicular traffic equipped with high-intensity beams. Such beams reflect on the windshield to generate discomforting glare which may be capable of creating optical hindrance to the occupant. This discomforting glare also enhances the probability of accidents by inducing temporary blindness and impairing the ability of the driver to adequately perceive the roadway ahead. Moreover, continuous exposure to high-intensity beams results in ocular strain and discomfort.

Traditional automotive mechanisms facilitate the regulation of the high-intensity beams of the vehicle to mitigate driver glare. This is achieved through various means such as diverse headlight designs, automatic dimming systems incorporating semiconductor devices, polarized lighting, and the use of apertures. Despite such advancements, the drivers remain at risk of collision incidents when high-intensity beams are emitted from the oncoming vehicles.

Accordingly, there is a requirement for a solution to reduce glare generated by influx of light impinging on the windshield by oncoming vehicles or the solar radiation.

### SUMMARY

In an embodiment, a system for reducing glare in a windshield is disclosed. The system may include a photochromic layer formed on the windshield. The photochromic layer may include a plurality of regions. Each region may be configured to receive an influx of light from an external light source. The system may further include a sensor unit disposed on the windshield and configured to generate sensor data based on the influx of light impinging on the plurality of regions. The system may further include a light source disposed on a periphery of the windshield configured to impart light on the plurality of regions. The system may further include a control unit communicably coupled to the sensor unit and the light source. The control unit may be configured to generate an activation command based on the sensor data received from the sensor unit. In response to the activation command, the control unit may be configured to activate the light source, to impart light on at least one region from the plurality of regions when the influx of light impinging increases above a predefined influx threshold to reduce glare on the at least one region.

In another embodiment, a method for reducing glare in a windshield is disclosed. The method may include generating, by a control unit, an activation command based on sensor data received from a sensor unit disposed on the windshield. The sensor data may be generated in response to an influx of light impinging on a plurality of regions of a photochromic layer formed on the windshield. The method may further include activating, by the control unit, a light source disposed on a periphery of the windshield to impart light on at least one region from the plurality of regions of the photochromic layer when the influx of light impinging increases above a predefined influx threshold and reduce glare on at least one region.

In yet another embodiment, a vehicle is disclosed. The vehicle may include at least one windshield, and a photochromic layer formed on each windshield. The photochromic layer may include a plurality of regions. Each region may be configured to receive an influx of light from an external light source. The vehicle may further include a sensor unit disposed on each windshield configured to generate sensor data based on the influx of light impinging on the plurality of regions. The vehicle may further include a light source disposed on a periphery of each windshield configured to impart light on the plurality of regions. The vehicle may further include a control unit communicably coupled to the sensor unit and the light source. The control unit may be configured to generate an activation command based on the sensor data received from the sensor unit. In response to the activation command, the control unit may be configured to activate the light source to impart light on at least one region from the plurality of regions when the influx of light impinging increases above a predefined influx threshold to reduce glare on the at least one region.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a windshield equipped with a system for reducing glare, in accordance with an embodiment of the present disclosure.

FIG. 2 illustrates a front view of the windshield, in accordance with an embodiment of the present disclosure.

FIG. 3 illustrates an inner perspective view of a cabin of a vehicle, in accordance with an embodiment of the present disclosure.

FIG. 4 illustrates another inner perspective view of the cabin of the vehicle, in accordance with an embodiment of the present disclosure.

FIG. 5 illustrates a flow chart of methodology for reducing glare, in accordance with an embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

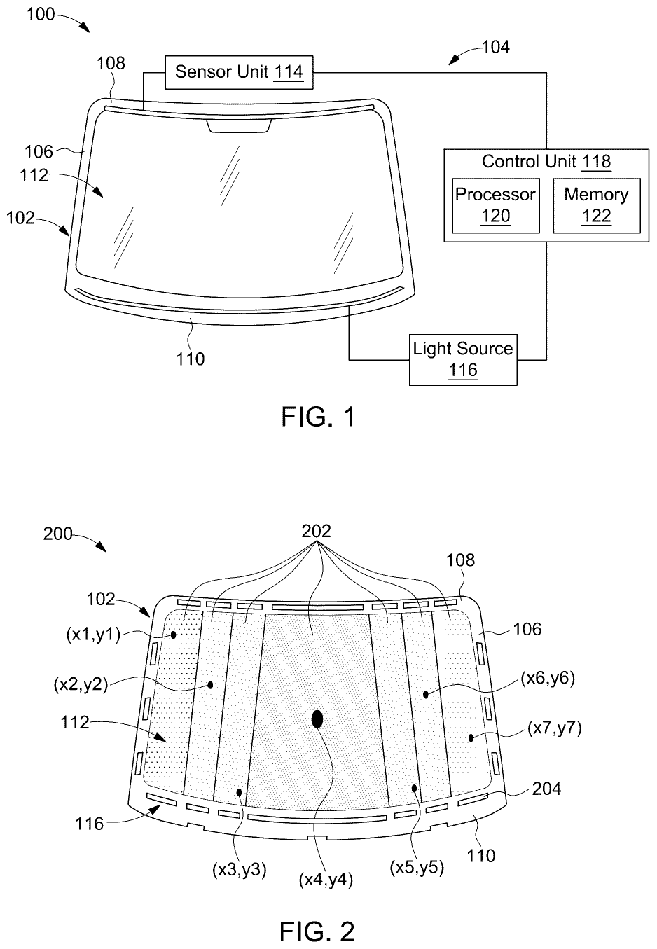

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-5. It is to be noted that, the system may be employed in any vehicle including but not limited to a passenger vehicle, a utility vehicle, heavy commercial vehicles, and any other transportable machinery.

Referring to FIG. 1, a block diagram 100 of a windshield 102 equipped with a system 104 of reducing glare is illustrated, in accordance with an embodiment of the present disclosure. The windshield 102 may be coupled to a vehicle using a combination/I of adhesive, rubber seals, fasteners, and the like. By way of example, the vehicle may include, but not limited to, cars, buses, trucks, aircrafts, locomotives, and the like. The windshield 102 may define a surface (not shown in FIG. 1) and a periphery 106 formed around the surface. The surface may be formed by a transparent or semi-transparent material for example, laminated glass, tampered glass, polycarbonate glass, and the like. The surface may be designed to provide visibility and protection from dust, debris, and the like. Further, the surface may be configured to receive an influx of light from an external source. The external light source may include but not limited to an influx of light generating from an oncoming vehicle or from solar radiations. In the example of oncoming vehicles, the influx of light may be a high-intensity beam and in the example of solar radiation, the influx of light may be a UV-light reflecting on the surface (not shown in FIG. 1) of the windshield 102. Further, the periphery 106 may include a top section 108 and a bottom section 110 disposed opposite the top section 108. The top section 108 and the bottom section 110 may collectively form a structural frame which provides support and rigidity to the surface. The structural frame may be made from metal, plastic, or other materials, and may be adjoined to a body panel of the vehicle. It is to be noted, when the surface of the windshield 102 may receive the influx of light above a predefined influx threshold, the light enters eyes of the occupant and reflects off the surface of the windshield. Accordingly, a discomfort glare (hereinafter referred to as a glare) may be generated. This glare may be capable of distorting a front view of the occupant and chances of crash event increases drastically.

Therefore, the system 104 may be disposed on each windshield 102 of the vehicle. The system 104 may be configured to reduce the glare generated on the surface of the windshield 102 by an external light source. For example, the glare may be reduced by increasing a degree of tint of the windshield 102 such that discomfort to the eyes of an occupant may be eliminated. By way of example, the degree of tint may include a visible light transmission (VLT) which defines a percentage of visible light allowed to pass through the windshield 102. For example, a higher percentage may define a more passage of influx of light through the windshield 102, and the windshield 102 may appear lighter. Similarly, a lower percentage may define a lower percentage of influx of light passes through the windshield 102, and the windshield 102 may appear darker.

In an embodiment, the system 104 may include a photochromic layer 112, a sensor unit 114, a light source 116, and a control unit 118. The photochromic layer 112 may be formed on the windshield 102, and may include a plurality of regions (not shown in FIG. 1). Each region may be configured to receive the influx of light from the external source. By way of example, the photochromic layer 112 may define a coating configured to change color or transparency in response to exposure of the influx of the light. As will be appreciated by the person skilled in the art, the photochromic layer 112 may include, but not limited to, a transition XTRActive lens defining a plurality of photochromic molecules. The plurality of molecules may respond to both the UV-light and high-intensity beam (e.g. visible, clear or white) from the external source, and may be aligned or oriented to form a dark region, to block or reduce the influx of light from the external source on the windshield 102. Therefore, the photochromic layer 112 may be configured to enable protection from the UV-light and high-intensity beam when the vehicle is in transient state and the occupant may be in influence of the influx of light from the external source. Such protection may be enabled upon determining the intensity of the UV-light and high-intensity beam impinging on the windshield 104. This is explained in greater detail hereinafter.

The system 104 may include a sensor unit 114 adjoined to the windshield 102. The sensor unit 114 may be configured to generate the senor data in response to the influx of light impinging on the windshield 102, particularly the photochromic layer 112. For example, the sensor unit 114 may include a light sensor coupled to the top section 108 and the bottom section 110 of the windshield 102, and may be configured to detect influx of light impinging on the windshield 102. Further, the sensor unit 114 may include an eye-tracking sensor equipped within the vehicle and may be configured to dynamically track the position and movement of eyes of the occupant relative to the plurality of regions. By way of example, the eye-tracking sensor may include an imaging sensor, a 3D-camera, and the like, disposed in a cabin (not shown) of the vehicle facing the eyes of the occupant. In an embodiment, the position of the eyes of the occupant may be determined with respect to a predefined vehicle origin of the vehicle and the dynamic movement of the eyes. The dynamic movement of the eyes may be determined based on an image data captured by the eye-tracking sensor. By virtue of the determination of the dynamic movement of the eyes and the predefined vehicle origin, the dynamic position of the eyes of the occupant relative to the plurality of regions may be determined. Accordingly, the sensor unit 114 may be configured to generate the sensor data in response to the influx of light impinging on the photochromic layer 112, and the position and movement of eyes of the occupant. This sensor data may be processed by the control unit 118 to determine the at least one region from the plurality of regions and the degree of tint on the at least one region to reduce the glare thereupon.

In an embodiment, the system 100 may include the light source 116 equipped on a periphery 106 of the windshield 102 and configured to impart light on the photochromic layer 112. The light source 116 may include an array of light emitting diodes (LEDs) (not shown in FIG. 1) formed corresponding to the plurality of regions. The at least one LED from the array of LEDs may be activated by the control unit 118 to impart the light on the at least one region. The at least one region may be determined by the control unit 118. Further, the control unit 118 may include a processor 120 and a memory communicably coupled to the processor 120.

In an embodiment, examples of processor(s) 120 may include, but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors. In an embodiment, the memory 122 may be a non-volatile memory or a volatile memory. Examples of non-volatile memory may include but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access memory (SRAM). The memory 122 may store instructions that, when executed by the processor 120, cause the processor 120 to perform various operations in order to reduce the glare from the influx of the light.

In an embodiment, the control unit 118 may be a microcontroller. Further, the control unit 118 may be used to control various aspects of system 104 equipped within the vehicle. By way of an example, the control unit 118 may be implemented as an embedded system in automotive electronics that may control one or more of the electrical systems or subsystems in the vehicle. The control unit 118 may be electrically and operatively coupled to the sensor unit 114 and the light source 116.

In an embodiment, the control unit 118 may be communicatively connected to the sensor unit 114 and the light source 116 via vehicle communication bus, operating on wireless protocols, including, but not limited to A²B (Automotive Audio Bus), AFDX, ARINC 429, Byteflight, CAN (Control unit Area Network), D2B—(Domestic Digital Bus), FlexRay, IDB-1394, IEBus, I²C, ISO 9141-1/-2, J1708 and J1587, J1850, J1939 and ISO 11783—an adaptation of CAN for commercial (J1939) and agricultural (ISO 11783) vehicles, Keyword Protocol 2000 (KWP2000), LIN (Local Interconnect Network), MOST (Media Oriented Systems Transport), IEC 61375, SMARTwireX, SPI, and/or VAN—(Vehicle Area Network), and the like.

The control unit 118 may be configured to receive the sensor data from the sensor unit 114. The control unit 118 may process the sensor data to determine the influx of light impinging above a predefined influx threshold and the position and the movement of the eyes relative to the plurality of regions. Upon determining the influx of light impinging above the predefined influx threshold, the control unit 118 may be configured to generate an activation command. In response to the activation command, the control unit 118 may activate the light source 118 to impart light on the at least one region from the plurality of regions when the influx of light impinging increases above the predefined influx threshold to reduce glare on the at least one region.

To elaborate further, the control unit 118 may determine the at least one region from the plurality of regions with the influx of light impinging above the predefined influx threshold, and the position and the movement of the eyes may be on the corresponding at least one region. Further, the control unit 118 may determine the degree of tint corresponding to the at least one region. In response to the determination of the degree of tint, the control unit 118 may generate an activation signal to activate the light source 116 corresponding to the at least one region to increase the degree of tint on the at least one region and reduce the glare from the influx of light. For example, the at least one LED from the array of LEDs corresponding to the at least one region may be activated to impart light on the at least one region. Therefore, the glare from the influx of light may be reduced.

In an embodiment, referring to FIG. 2, which illustrates a front view 200 of the windshield 102, in accordance with an embodiment of the present disclosure. As explained earlier, the photochromic layer 112 may be formed on the windshield 102. The photochromic layer 112 may include a plurality of regions 202, each region 202 defining the degree of tint. The degree of tint may be increased or decreased based on light imparted by the light source 116 thereupon. The degree of tint may be configured to reduce the influx of light. The degree of the tint may be adjusted when the influx of the light on the at least one region 202 may increase above the predefined influx threshold, and the position and movement of eyes of the occupant on the corresponding at least one region 202. In an embodiment, the position of the eyes of the occupant during the dynamic movement of the eyes may be looked up in an reference table as described later to determine the at least one region 202, and the degree of tint required to be maintained in corresponding to the at least one region 202.

The degree of tint may be adjusted by activation of the light source 116. As explained earlier, the light source 116 may include an array of light emitting diodes (LEDs) 204 formed corresponding to the plurality of regions 202. The at least one LED 204 from the array of LEDs 204 may be determined by the control unit 118 based on the position of the eyes. Further, the corresponding at least one LED 204 may be activated to impart the light on the at least one region 202. The intensity of the at least one LED 204 from the array of LEDs 204 may be based on the degree of the tint on the at least one region 202. The degree of tint may be configured to reduce the influx of the light on the at least one region.

As evident from Table 1 presented below, it can be seen that the plurality of regions 202 may be configured to receive the influx of light. Each region 202 may be sequentially formed to define the degree of tint. The degree of tint may be regulated by the control unit 118 based on the activation of the at least one LED 204 when the influx of light increases above the predefined influx threshold i.e., 12 lux and the position of the eyes of the occupant may be on the at least one region 202 from the plurality of regions 202. It is to be noted, the occupant may be sitting relative to the plurality of regions 202 and each region 202 may correspond to the position of the eyes of the occupant. The position of the eyes may be depicted on the plurality of regions 202 via a plurality of co-ordinates for example, (x1, y1), (x2, y2), (x3, y3), (x4, y4), (x5, y5), (x6, y6), and (x7, y7). For example, the influx of light i.e., 5 lux corresponds to the (x1, y1) co-ordinates, the influx of light i.e., 10 lux corresponds to the (x2, y2) co-ordinates, the influx of light i.e., 5 lux corresponds to the (x3, y3) co-ordinates, the influx of light i.e., 30 lux corresponds to the (x4, y4) co-ordinates, the influx of light i.e., the influx of light i.e., 20 lux corresponds to the (x5, y5) co-ordinates, the influx of light i.e., 18 lux corresponds to the (x6, y6) co-ordinates, and the influx of light i.e., 16 lux corresponds to the (x7, y7) co-ordinates.

As shown in Table 1, the influx of light increases above the predefined influx threshold i.e., 12 lux may be determined. Further, when the influx of light is 5 lux and the position of the eyes of occupant may be in the (x1, y1) co-ordinates, the degree of tint may be 5% i.e., the influx of light is determined below the predefined influx threshold i.e., 12 lux. As may be appreciated, the glare from the influx of light may be comforting to the eyes of occupant. Furthermore, the 5% degree of tint depicts the 95% of the light may pass through the photochromic layer 112. Similarly, when the influx of light is 10 lux and the position of the eyes of the occupant is in the (x2, y2) co-ordinates, the degree of tint may be 10% i.e., the influx of light is determined below the predefined influx threshold i.e., 12 lux. Therefore, the glare from the influx of light may be comforting to the eyes of the occupant. As will be appreciated by the person skilled in the art, the influx of light below the predefined influx threshold depicts comforting glare generation which may allow the occupant to perceive the roadway ahead comfortably.

Further, when the influx of light is 15 lux and the position of the eyes of occupant is in the (x3, y3) co-ordinates, the control unit 118 may generate an activation signal to activate the at least one LED 204 corresponding to the (x3, y3) co-ordinates to increase the degree of tint by 15%. Accordingly, the glare and the influx of light impinging on the eyes of occupant directly may be reduced to ensure smooth operation of the vehicle. When influx of light is 30 lux and the position of the eyes of occupant is in the (x4, y4) co-ordinates, the control unit 118 may generate an activation signal to activate the at least one LED 204 corresponding to the (x4, y4) co-ordinates to increase the degree of tint by 30% and to reduce the glare and the influx of light impinging on the eyes of occupant. Further, when influx of light is 20 lux and the position of the eyes of occupant is in the (x5, y5) co-ordinates, the control unit 118 may generate an activation signal to activate the at least one LED 204 corresponding to the (x5, y5) co-ordinates to increase the degree of tint by 20% and to reduce the glare and the influx of light impinging on the eyes of occupant. Further, when influx of light is 18 lux and the position of the eyes is in the (x6, y6) co-ordinates, the control unit 118 may generate an activation signal to activate the at least one LED 204 corresponding to the (x6, y6) co-ordinates to increase the degree of tint by 18% to reduce the glare and the influx of light impinging on the eyes of occupant. When influx of light is 16 lux and the position of the eyes of occupant is in the (x7, y7) co-ordinates, the control unit 118 may generate an activation signal to activate the at least one LED 204 corresponding to the (x7, y7) co-ordinates to increase the degree of tint by 16% and to reduce the glare and the influx of light impinging on the eyes of occupant. The determination of the at least one region 202 and position of the eyes of the occupant on the at least one region is already explained in conjunction with FIG. 1. Further, the activation of the at least one LED 204 from the plurality of LEDs 204 is already explained in greater detail in conjunction with FIG. 1.

TABLE 1

| Influx of | Predefined Influx | Eye-tracking | Degree |
|---|---|---|---|
| light (lux) | Threshold (lux) | Region | of tint |
| 5 | 12 | (x1, y1) | 5% |
| 10 | | (x2, y2) | 10% |
| 15 | | (x3, y3) | 15% |
| 30 | | (x4, y4) | 30% |
| 20 | | (x5, y5) | 20% |
| 18 | | (x6, y6) | 18% |
| 16 | | (x7, y7) | 16% |

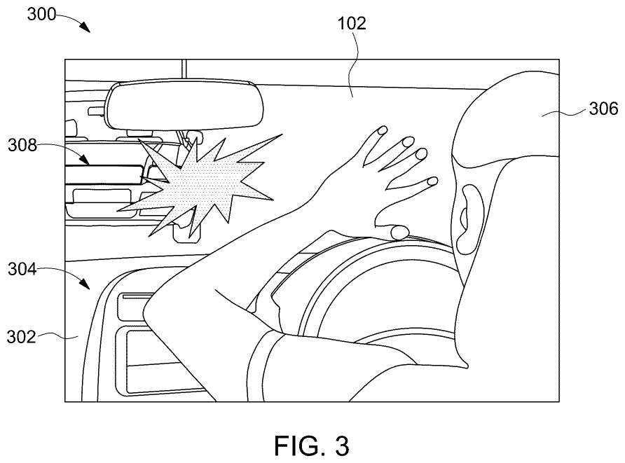

In an embodiment, referring to FIG. 3, which illustrates an inner perspective view 300 of a cabin 302 of a vehicle 304, in accordance with an embodiment of the present disclosure. FIG. 3 depicts the influx of light impinging on the windshield 102 from an oncoming vehicle 306 in absence of the photochromic layer 112. Due to absence of the photochromic layer 112, the influx of light impinging generates the glare which may be capable of distorting the position and movement of the eyes of an occupant 308. In other words, the eyes of the occupant 308 are clinched, resulting in temporary blindness. Such blindness may render the occupant 308 in a vulnerable scenario such as crash event. As will be appreciated by the person skilled in the art, the crash events may be prevented by the system 104 by reducing glare on the windshield 102. The reduction of the glare in the windshield 102 is explained in greater detail, hereinafter.

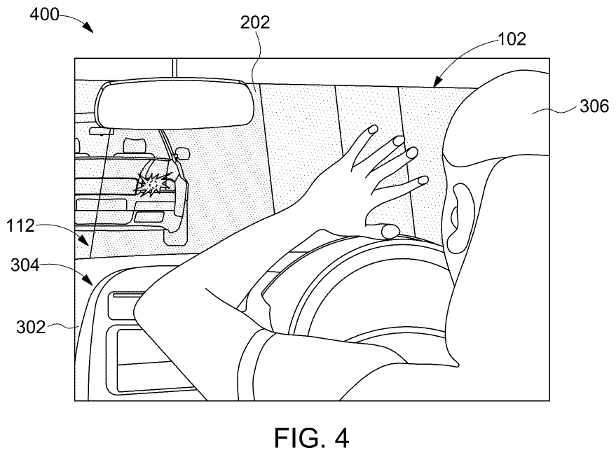

In an embodiment, referring to FIG. 4, which illustrates another inner perspective view 300 of the cabin 302 of the vehicle 304, in accordance with an embodiment of the present disclosure. FIG. 4 is explained in conjunction with FIG. 3. As apparent from FIG. 4, the windshield 102 may be equipped with the system 104. Further, windshield 02 may be formed with the photochromic layer 112. Furthermore, the photochromic layer 112 may be configured to receive the influx of light from the external source i.e., the oncoming vehicle 306 or the solar radiations. As the influx of light impinged on the photochromic layer 112, control unit 118 may determine the at least one region 202 with the influx of light above the predefined influx threshold i.e., 12 lux and the position of the eyes of the occupant 308 may be on the plurality of the co-ordinates (x1, y1), (x2, y2), (x3, y3), (x4, y4), (x5, y5), (x6, y6), and (x7, y7). This is already explained in FIG. 2. Further, the degree to tint may be determined by the control unit 118 on the corresponding at least one region 202. Thus, activating the at least one LED 204 corresponding to the at least one region 202 to impart the light on the at least one region 202. By virtue of the imparting of the light, the degree of tint may be increased on the at least one region and the glare from the influx of light may be reduced.

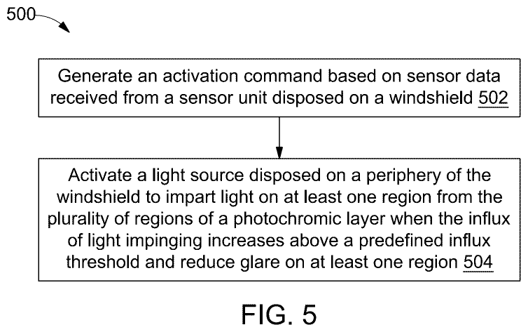

In an embodiment, referring to FIG. 5, which illustrates a flow chart 500 of a methodology for reducing glare in the windshield 102, in accordance with an embodiment of the present disclosure. It is to be noted that the control unit 118 may perform the steps of the flow chart 500. At step 502, the control unit 118 may generate an activation command based on sensor data received from the sensor unit 114. Moreover, the control unit 118 may determine the at least one region 202 from the plurality of regions 202 with the influx of the light above the predefined influx threshold, and position of the eyes on the corresponding at least one region 202. Further, the degree of tint corresponding to the at least one region 202 may be determined. At step 504, in response to the activation command, the control unit 118 may activate the light source 116 disposed on the periphery 106 of the windshield 102. Such activation of the light source 116 may enable the imparting of the light on the at least one region 202 from the plurality of regions 202 when the influx of light increases above the predefined influx threshold and reduce glare on the at least one region 202. Moreover, the control unit 118 may activate the at least one LED 204 from the array of LEDs 204 to impart the light on the at least one region 202 to increase the degree of tint and reduce the glare on the windshield 102. This is already explained in conjunction with FIGS. 1-4.

As will be appreciated by those skilled in the art, the design described in the various embodiments discussed above are not routine, or conventional, or well-understood in the art. The techniques discussed above provide the integration of the photochromic layer 112 on the windshield such that the glare may be reduced.

In light of the above-mentioned advantages and the technical advancements provided by the disclosed system and method, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

Thus, the disclosed system and method try to overcome the technical problem of reducing discomfort glare generated when the influx of light increases above the predefined influx threshold. When the influx of light is determined above the predefined influx threshold, the at least one LED corresponding to the at least one region from the plurality of regions may be activated. The at least one region may be determined based on the position of the eyes of the occupant. Therefore, the degree of tint may be increased and the glare may be reduced. Due to which the chances of crash events may be prevented, and the driving experience of the occupant may be enhanced.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for reducing glare in a windshield, the system comprising:
a photochromic layer formed on the windshield, wherein the photochromic layer comprises:
a plurality of regions, wherein each region is configured to receive an influx of light from an external light source;
a sensor unit disposed on the windshield configured to generate sensor data based on the influx of light impinging on the plurality of regions;
a light source disposed on a periphery of the windshield configured to impart light on the plurality of regions; and
a control unit communicably coupled to the sensor unit and the light source, wherein the control unit is configured to:
generate an activation command based on the sensor data received from the sensor unit; and
activate the light source, in response to the activation command, to impart light on at least one region from the plurality of regions when the influx of light impinging increases above a predefined influx threshold to reduce glare on the at least one region.

2. The system of claim 1, wherein the sensor unit comprises:
a light sensor coupled to a top section and a bottom section of the windshield, and configured to detect the influx of the light imping on the windshield; and
an eye-tracking sensor disposed within a vehicle (304) and configured to dynamically track position and movement of eyes of an occupant (308) relative to the plurality of regions.

3. The system of claim 1, wherein each region from the plurality of regions defines a degree of tint, wherein the degree of tint is increased or decreased based on light imparted by the light source thereupon, and wherein the degree of tint is configured to reduce the influx of light.

4. The system of claim 3, wherein the control unit is configured to:
determine at least one region from the plurality of regions with the influx of the light above the predefined influx threshold, and position of eyes on the corresponding at least one region;
determine the degree of tint corresponding to the at least one region; and
activate the light source corresponding to the at least one region to increase the degree of tint on the at least one region and reduce the glare from the influx of light.

5. The system of claim 4, wherein the light source comprises:
an array of light emitting diodes (LEDs) formed corresponding to the plurality of regions, wherein at least one LED from the array of LEDs is activated to impart the light on the at least one region.

6. A method for reducing glare in a windshield, the method comprising:
generating, by a control unit, an activation command based on sensor data received from a sensor unit disposed on the windshield, wherein the sensor data is generated in response to an influx of light impinging on a plurality of regions of a photochromic layer formed on the windshield; and
activating, by the control unit, a light source disposed on a periphery of the windshield to impart light on at least one region from the plurality of regions of the photochromic layer when the influx of light impinging increases above a predefined influx threshold and reduce glare on at least one region.

7. The method of claim 6, wherein the sensor unit comprises:
a light sensor coupled to a top section and a bottom section of the windshield, and configured to detect the influx of the light imping on the windshield; and
an eye-tracking sensor disposed within a vehicle (304) and configured to dynamically track position and movement of eyes of an occupant (308) relative to the plurality of regions.

8. The method of claim 6, wherein each photochromic layer defines a degree of tint, wherein the degree of tint is increased or decreased based on light imparted by the light source thereupon, and wherein the degree of tint is configured to reduce the influx of light.

9. The method of claim 8, wherein the control unit is configured to:
determining, by the control unit, at least one region from the plurality of regions with the influx of the light above the predefined influx threshold, and position of eyes on the corresponding at least one region;
determining, by the control unit, the degree of tint corresponding to the at least one region; and
activating, by the control unit, the light source corresponding to the at least one region to increase the degree of tint on the at least one region and reduce the glare from the influx of light.

10. The method of claim 9, wherein the light source comprises:
an array of light emitting diodes (LEDs) formed corresponding to the plurality of regions, wherein at least one LED from the array of LEDs is activated to impart the light on the at least one region.

11. A vehicle, comprising:
at least one windshield;
a photochromic layer formed on each windshield, wherein the photochromic layer comprises:
a plurality of regions, wherein each region is configured to receive an influx of light from an external light source;
a sensor unit disposed on each windshield configured to generate sensor data based on the influx of light impinging on the plurality of regions;
a light source disposed on a periphery of each windshield configured to impart light on the plurality of regions; and
a control unit communicably coupled to the sensor unit and the light source, wherein the control unit is configured to:
generate an activation command based on the sensor data received from the sensor unit; and
activate the light source, in response to the activation command, to impart light on at least one region from the plurality of regions when the influx of light impinging increases above a predefined influx threshold to reduce glare on the at least one region.
